(19) United States
(12) Patent Application Publication
(10) Pub. No.: US 2026/0160384 A1
(43) Pub. Date: Jun. 11, 2026

(54) SUPPORT BRACKET FOR CEILING INSTALLATION OF HEATING/COOLING UNIT

(71) Applicant: Mechanical Solutions, LLC, Lynnwood, WA (US)

(72) Inventors: David Sweeten, Lynnwood, WA (US); Josh Carter, Bothel, WA (US)

(73) Assignee: Mechanical Solutions, LLC, Lynnwood, WA (US)

(21) Appl. No.: 19/180,410

(22) Filed: Apr. 16, 2025

Related U.S. Application Data
(60) Provisional application No. 63/634,494, filed on Apr. 16, 2024.

(51) Int. Cl. F16M 13/02; F24F 1/0047; F24F 13/32

(52) U.S. Cl. CPC F16M 13/027; F24F 1/0047; F24F 13/32

(57) ABSTRACT

A bracket for installation of a ductless split HVAC system is described herein. The bracket includes a base support member, a U-shaped support, and a threaded insert. The base support member is made from sheet steel, having a length of between 13 inches and 8 inches and a width between 5 inches and 2 inches. The U-shaped support is made from sheet steel, welded to the base support member, which has a topmost portion representing an open portion of the U shape located between 0 and 4 inches from the top of the base support member, which is approximately centered on the base support member. The threaded insert is centered in the bottom section of the U shape. The threaded insert is configured to thread a bolt or rod having an opposing threaded end configured to be threaded to one of four threaded inserts of the ceiling mount, indoor unit.

### CLAIM OF PRIORITY

This application claims priority to U.S. Provisional Patent Application No. 63/634,494 filed on Apr. 16, 2024, entitled “SUPPORT BRACKET FOR CEILING INSTALLATION OF HEATING/COOLING UNIT”, the contents of which are hereby fully incorporated by reference.

### FIELD OF THE EMBODIMENTS

The field of the invention and its embodiments relate to the installation of heat pumps and/or air conditioning (AC) units, and more specifically to an installation kit including a novel support Bracket for Ceiling Installation of Heating/Cooling Unit or cassettes.

### BACKGROUND OF THE EMBODIMENTS

Heat pump and/or air conditioning (AC) ceiling units, and especially those that are ductless, are extremely popular partially due to their discrete appearance, space maximization, and customizable air flows. Mounted units, also called mini split units and ceiling cassettes, have a discrete appearance as they are located above eye level, such that a majority of the unit is hidden above a ceiling with only a small grill around one-inch-thick showing. An example of such a unit is shown in FIG. 3C (Prior Art). Space is maximized because they are mounted in the ceiling, rather than a floor or wall. They do not accept appreciable livable space. A ceiling unit typically has four outlets, which can be selectively opened or closed to ensure desirable directed airflow.

Proper installation of ceiling units is often problematic, especially for do-it-yourself (DIY) projects. Installation requires careful placement, which should avoid overt exposure to higher or lower temperatures, as doing so could result in incorrect temperature readings and adjustments.

Despite their common usage, few universal installation kits exist. FIG. 3A (Prior Art) shows one of these, specifically the QUICK-SLING ductless cassette hanger kit by DIVERSITECH. This kit purports to utilize an innovative bracket (shown) made of lightweight aluminum, which permits alignment adjustments after the unit has been hung.

FIG. 3B (Prior Art) shows a different mini split ceiling cassette hanging kit by BUDGETHEATING.COM. This kit includes four lag bolts, one five-foot length angle iron, a set of 16 washers and nuts, and four six-foot threaded rods.

Known available kits for hanging ceiling units are deficient for many situations and needs. Typically, licensed installers, who do not rely on available kits, develop their own ad-hoc methodologies and sets of components for installation, which may differ greatly in cost and quality depending on installer choices. What is needed is a universal kit for mounting units that is significantly more robust and versatile than known kits while still being of sufficiently high quality and ease for DYI and professional installers alike.

### RELATED ART

JP05149574A discloses a ceiling cassette air conditioner whose body is mounted to a ceiling opening through hanging bolts. A cushion member housed in a packing box together with the air conditioner body is provided with an engaging slit which engages the cushion member with the ceiling opening. A positioning part is provided for determining the pitch between the hanging bolts and length of the hanging screws.

KR100906183B1 discloses a mounting kit for a ceiling cassette type air conditioner is provided to install a body part of an indoor unit of the air conditioner at a precisely position and improve the workability for reducing the manpower and time required for the installation.

JP2002257409A discloses an indoor machine wherein a work to install the indoor machine at a ceiling is simplified and work time is reduced by providing an installation fixture with the indoor machine of a ceiling cassette type air conditioner.

DE202022002125U1 discloses a bracket, made of sheet steel or aluminum, for mounting radiators and electric radiators on walls and ceilings. Characterized by the fact that the sheet metal construction is double folded at the upper and lower end to create flat contact surfaces on the wall/ceiling and the radiator to be suspended

### SUMMARY OF THE EMBODIMENTS

One aspect of the disclosure includes a bracket for the installation of a ceiling mounted, indoor unit. The bracket is made from sheet steel and has a length of between thirteen inches and 8 inches and a width between 5 inches and 2 inches. The bracket can be part of a universal kit for installing various sized ceiling mount indoor units. The U-shaped support being made from sheet steel, welded to the base support member, which has a topmost portion representing an open portion of the U shape located between 0 and 4 inches from a top of the base support member, which is approximately centered on the base support member. The threaded insert being centered in a bottom section of the U shape. The threaded insert is configured to thread a bolt or rod having an opposing threaded end configured to be threaded to one of four threaded inserts of the ceiling mount, indoor unit.

Another aspect of the disclosure includes a kit for the installation of a ceiling mounted, indoor unit of a ductless split HVAC system. The kit includes four brackets, each including a base support member, a U-shaped support, and a threaded insert. Each bracket being made from sheet steel, having a length of between 13 inches and 8 inches, and having a width between 5 inches and 2 inches. The U-shaped support being made from sheet steel, welded to the base support member, which has a topmost portion representing an open portion of the U shape located between 0 and 4 inches from a top of the base support member, which is centered on the base support member. The threaded insert being centered in the bottom section of the U shape. The threaded insert is configured to thread a bolt or rod having an opposing threaded end configured to be threaded to one of four threaded inserts of the ceiling mount, indoor unit.

Another aspect of the disclosure includes a mounting for installation of a ceiling mount, indoor unit of a ductless split HVAC system. The mounting can include four brackets, four threaded rods or bolts, and a framing. Each of the four brackets includes a base support member, a U-shaped support, and a threaded insert. The base support member is made from sheet steel, having a length of between thirteen inches and 8 inches and a width between 5 inches and 2 inches. The U-shaped support is made from sheet steel, welded to the base support member, which has a topmost portion representing an open portion of the U shape located between 0 and 4 inches from a top of the base support member and centered on the base support member. The threaded insert is centered in the bottom section of the U shape. The threaded insert is configured to thread a bolt or rod having an opposing threaded end configured to be threaded to one of four threaded inserts of the ceiling mount, indoor unit. The base support member includes a plurality of holes pre-punched into each of the base support members. At least a portion of the holes run in parallel along a length of the bracket below the U-shaped support. The holes are configured for screw attachment to the framing. The four threaded rods or bolts connect on one end to the threaded inserts of the respect brackets. Opposing ends of the rods/bolts are threaded to a respective one of four threaded inserts of the ceiling mount, indoor unit. The brackets are configured such that downward vertical forces resulting from gravity is countered by equivalent upward vertical forces applied to the brackets by virtue of being connected via the bolts or rods at the threaded insert of the respective brackets. The framing is configured to surround an outer perimeter of the ceiling mount, indoor unit. The framing is connected to each of the four brackets on the interior of the frame via screws connecting through the holes.

### BRIEF DESCRIPTION OF THE DRAWINGS

FIG. 1A depicts a universal kit for installing ductless ceiling cassettes, in accordance with embodiments of the present invention.

FIG. 1B depicts a model of a bracket, in accordance with embodiments of the present invention.

FIG. 1C provides a perspective view of the bracket, in accordance with embodiments of the present invention.

FIG. 1D provides a front perspective view of an embodiment of bracket, in accordance with embodiments of the present invention.

FIG. 2A shows four brackets being used in conjunction with a framing, which supports a heating/cooling unit, in accordance with embodiments of the present invention.

FIG. 2B shows brackets used in conjunction with a framing for a heating/cooling unit, in accordance with embodiments of the present invention.

FIG. 3A (Prior Art) shows a ductless cassette hanger kit by DIVERSITECH, in accordance with embodiments of the present invention.

FIG. 3B (Prior Art) shows a ductless cassette hanger kit by BUDGETHEATING.COM, in accordance with embodiments of the present invention.

FIG. 3C (Prior Art) shows a ductless cassette or heating/cooling unit, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, an “embodiment” means that a particular feature, structure or characteristic is included in at least one or more manifestations, examples, or implementations of this invention. Furthermore, the particular features, structures or characteristics may be combined in any suitable manner, as would be apparent to a person having ordinary skill in the art. Combinations of features of different embodiments are meant to be within the scope of the invention, without the need for explicitly describing every possible permutation by example. Thus, any of the claimed embodiments can be used in any combination.

The phrase “and/or,” as used herein in the specification and in the claims, should be understood to mean “either or both” of the elements so conjoined, e.g., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements), etc.

As used herein, the word “include,” and its variants are intended to be non-limiting, such that recitation of items in a list is not to the exclusion of other like items that may also be useful in the compositions and methods of this technology. Similarly, the terms “can” and “may” and their variants are intended to be non-limiting, such that recitation that an embodiment can or may comprise certain elements or features does not exclude other embodiments of the present technology that do not contain those elements or features.

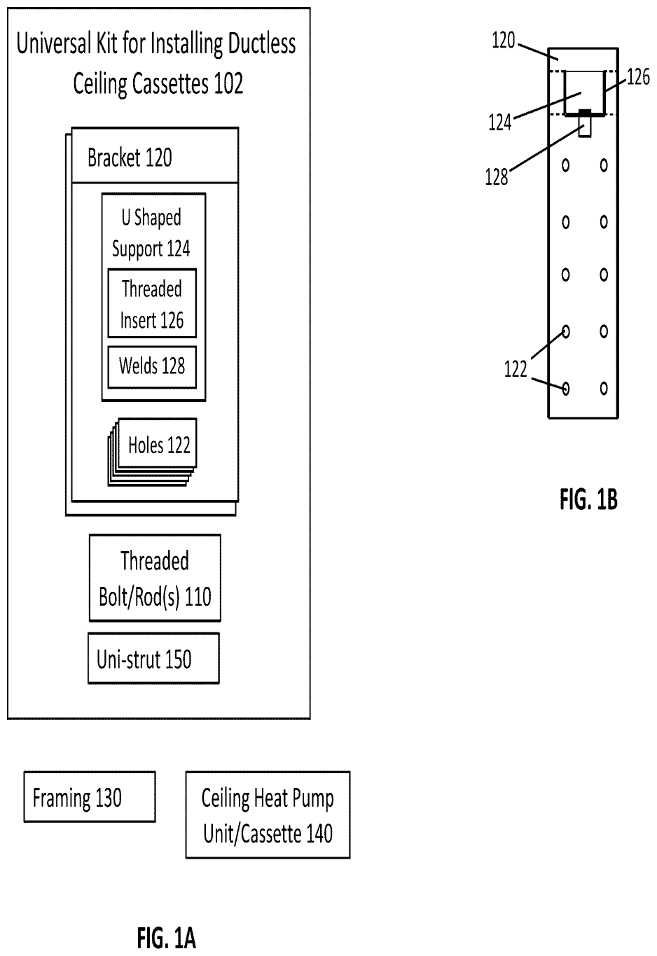

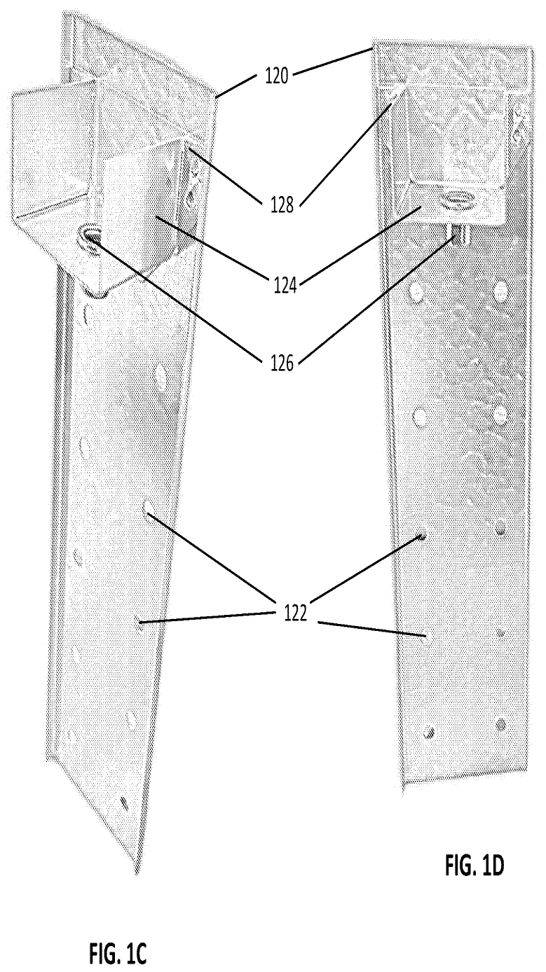

FIG. 1A depicts a universal kit for installing ductless ceiling cassettes 102, in accordance with embodiments of the disclosure. Kit 102 includes a set of brackets 120, each having a U-shaped support 124. The Support includes a threaded insert 126, and a set of welds 128 or other connectors, such as rivets, which connect it to the bracket's member. The threaded insert 126 permits insertion of appropriately sized threaded bolt and/or rod 110. In one embodiment, a unit-strut 150 can provide support between different brackets 120, when in use. Bracket 120 will generally be utilized with a framing 130 to support a ceiling heat pump unit 140 in a ceiling mounted fashion.

As used herein, a ceiling heat pump unit 140 is a component of split HVAC system generally consisting of two units; one installed in a ceiling indoors and another being installed outdoors. The indoor ceiling unit is often called a cassette. In this type of ductless system, the indoor air handler is not installed on a wall or floor, but is installed in the ceiling. The rest of the components are typically hidden away behind the ceiling.

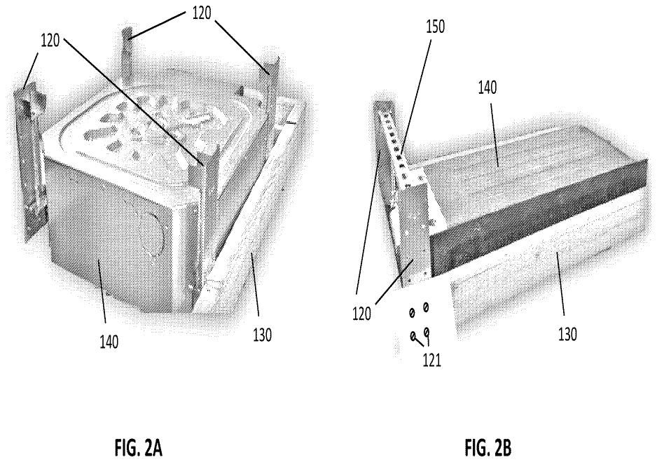

Elements introduced in FIG. 1A are more clearly illustrated with reference to FIGS. 1B-1D and 2A-2B FIG. 1A depicts a universal kit for installing ductless ceiling cassettes 102, in accordance with embodiments. FIG. 1C provides a perspective view of bracket 120, in accordance with embodiments. FIG. 1D provides a front perspective view of an embodiment of bracket 120.

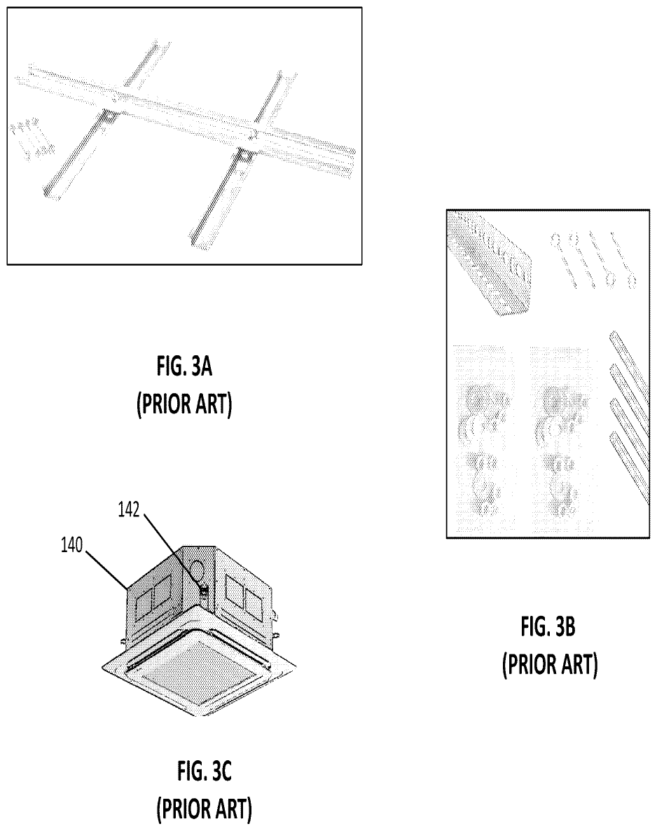

In one embodiment consistent with FIG. 1B-1D, the bracket 120 can be made from a 20-gage steel support bracket with a length of approximately 11″ and a width of approximately 3¼″. The holes 122 can be pre-punched ¼″ holes 122 on both the right and left sides running the length of the bracket below the U-shaped support 124. A total of five holes 122 per side can exist, as depicted. Screws can be attached through the holes 122 to support framing 130. Along a length of the bracket 120 as shown are ¼″ 90 degree bends running the whole length of each side for structural support and strength. Consistent with FIG. 1B-1D, a top portion of the bracket 120 has U-shaped support 120 welded to it, which is located ¼″ from a top of the bracket, which measures down to 1¾″ from the top of the bracket. The U-shaped support 120 can be a 20 gauge metal bent with 90 degree angles, each side having a 90 degree flange which is welded to the main bracket body. The U-shaped support 120 can measure 1¼″ high by 2″ wide by 1¾″ deep. Located in a bottom section of the U-shaped support 120 is a centered riveted ⅜″ threaded insert 126. The insert 126 can be used to thread a ⅜″ bolt or a ⅜″ all thread rod 110. Generally, threading on an installable unit 140 are also ⅜″ by convention, as illustrated in FIG. 3C for insert 142.

Preferably, the threading diameter of insert 126, matches that of bolt/rod 110, and insert 142, in preferred embodiments. Preferably, the bolt/rod 110 is fully threaded. In embodiments, double threaded, or partially threaded (with unthreaded sections) bolts/rods 110 can be utilized, so long as the threading is suitably paired to that of insert 126 and 124. In embodiments, a double threaded bolt/rod 110 having varying diameters can be used, which negates a need for inserts 126 and 142 to have the same threading diameter in such embodiments.

Although FIG. 1B-1D shows five holes 122 for framing on each side, which is a preferred embodiment, other arrangements of holes 122 for screws can be used. For example, a single row of five holes 122 can be used in one embodiment, which are vertically positioned in a centered fashion upon base member of bracket 120. Embodiments are contemplated with three rows of holes instead of two or one. In another embodiment, a series of 2, 3, 4, 6, 7 holes on each side can be used. Further, the holes for screws or other connectors need not be ¼″, but metric and/or alternative diameters can be effectively utilized. Generally, the diameter size of the holes 122 with correspond to a diameter of a screw to be used to secure elements of framing 130. In other embodiments, slits can be used instead of holes, which enables a wider range of placement.

The U-shaped support 124 need not have two ninety degrees, but can instead have tapered corners in embodiments. In other embodiments, a trapezoid shape can be used instead of a U. Importantly, the purpose of support 124 is to secure a stable attachment position for threaded insert 126. In embodiments, a portion of support 124 can be specifically designed to support endpoints of a uni-strut 150, such as shown in FIG. 2B. The width and depth of the U-shaped support 120 can be expressly designed to allow uni-strut 150 to fit within. The common width of a uni-strut is 1⅝″ wide.

Although, as noted twenty gauge steel is preferably used for bracket 120 and/or support 124 other gauges are contemplated. For example, 14, 16, 18, 22, 24, and 26 gauge steel may be used in embodiments, for one or more of bracket 120, support 124, or portions thereof. In embodiments, bracket 120, support 124, and/or uni-strut 150 can be made of sheet steel with a zinc coating (galvanized), paint, epoxy, power coat, or other finish. Used sheet steel can include Type 304 (SS), type 316 (ST) and type 321, in embodiments. In embodiments, sheet steal can be of various grades, such as A36, A572-50, A500, A516-70, AR400, A588 (Corten), or A1011. Other steel compositions can also be used. Further, alternative materials can be used for bracket 120 and/or support 124 in contemplated embodiments, such as aluminum alloys, titanium, and carbon fiber.

Although in a preferred embodiment, the length of the bracket 120 is eleven”, other lengths can be used, such as those from 6″ to 14″. Although in a preferred embodiment, a width of bracket 120 is approximately three ¼″, other width, such as those between 2 and 5″ can be used in various embodiments. The stated preferred dimensions of U-shaped support 124 can vary from those specified, such as within 50 percent +/− of stated values in contemplated embodiments. Similarly, the positioning of U shaped support 124 can vary from the noted preferred ones (between ¼″ from the top and extending down to one ¾″ from the top) in contemplated embodiments, such as being between a range of being flush with the top to being within 4″ from the top. General modifications to structures, dimensions, materials, appearances, etc. from those expressly mentioned herein, yet still able to effectively be utilized as substitutions, as known to one of ordinary skill in the art, are contemplated herein.

FIG. 2A shows four brackets 120 being used in conjunction with a framing 130, which supports unit 140. Only a partial framing 130 is shown to permit easy viewing of other significant elements. As shown in FIG. 2A, the threaded insert 126 within the U-shaped support 124 is above unit 140. Unit 140 includes threaded inserts such as insert 142 shown in FIG. 3C, which is a standard in the industry. The threading of insert 142 matches that of insert 126, which is preferably a ⅜ threading used to thread a ⅜″ bolt or a ⅜″ all thread rods. The bolt/rod 110 extending through insert 126 and 142 provides vertical support for unit 140. Unit 140 can be leveled at least in part by adjusting bolt/rod 110 within insert 126 (or 142).

FIG. 2B shows two brackets 120 (although four would be used total) for a different unit 140 having framing 130. Unlike the example of FIG. 2A, a uni-strut 150 is placed between the U-shaped supports 124 of two opposing brackets 120. A set of screw-heads 121 are shown, which can extend through framing 130 and into the bottom two sets of holes 122 of the corresponding bracket 120.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A bracket for installation of a ceiling mount, indoor unit of a ductless split HVAC system, comprising:
a base support member made from sheet steel; and
a U-shaped support made from sheet steel, welded to the base support member, which has a topmost portion representing an open portion of the U shape located between 0 and 4 inches from a top of the base support member and approximately centered on the base support member, said U-shaped support comprising:
a threaded insert centered in a bottom section of the U-shape, wherein said threaded insert is configured to thread a bolt or rod having an opposing threaded end configured to be threaded to one of four threaded inserts of the ceiling mount, indoor unit.

2. The bracket of claim 1, wherein a quantity of four of the brackets are configured to install one ceiling mount indoor unit, such that the threaded inserts of the respect brackets are configured to be threaded to a quantity of four bolts or rods, each having opposing ends threaded to a respective one of the four threaded inserts of the ceiling mount, indoor unit, wherein the bracket is configured such that downward vertical forces resulting from gravity is countered by substantially equivalent upward vertical forces applied to the brackets by virtue of being connected via the bolts or rods at the threaded insert of the respective brackets.

3. The bracket of claim 1, comprising an approximately ¼ inch, substantially 90 degree bend running approximately a whole length of each side of the bracket configured for enhanced structural support and strength.

4. The bracket of claim 1, further comprising:
a plurality of holes pre-punched into the base support member at least a portion of the holes running in parallel along a length of the bracket below the U-shaped support configured for screw attachment to a framing.

5. The bracket of claim 4, wherein the plurality of holes comprises at least six holes, arranged at approximately equal distances in a set two approximately parallel lines running along the length of the bracket, one of the approximately parallel lines of the holes being on a right and the other being on a left side of the length.

6. The bracket of claim 5, wherein the at least six holes comprises ten holes, wherein each of the parallel lines comprise five holes.

7. The bracket of claim 1, wherein each of the holes is substantially ¼ inch.

8. The bracket of claim 1, wherein the threaded insert is substantially ⅜ inch.

9. The bracket of claim 1, wherein the U-shaped support is bent with substantially 90 degree angles, wherein each side has a substantially 90 degree flange, which is welded to the base support member, wherein the U-shaped support measures 1¼ inches high by 2 inches wide, by 1¾ inches deep plus or minus 30 percent.

10. The bracket of claim 1, the U-shaped support member is configured to contain and support an endpoint of a standard sized uni-strut between the U-shaped opening, such that two of the brackets facing each other support both endpoints of the uni-strut within respective U-shaped support members.

11. A kit for installation of a ceiling mount, indoor unit of a ductless split HVAC system, comprising:
four brackets, each comprising:
a base support member made from sheet steel, having a length of between 13 inches and 8 inches and a width between 5 inches and 2 inches; and
a U-shaped support made from sheet steel, welded to the base support member, which has a topmost portion representing an open portion of the U shape located between 0 and 4 inches from a top of the base support member and approximately centered on the base support member, said U-shaped support comprising:
a threaded insert centered in a bottom section of the U-shape, wherein said threaded insert is configured to thread a bolt or rod having an opposing threaded end configured to be threaded to one of four threaded inserts of the ceiling mount, indoor unit.

12. The kit of claim 11, further comprising:
four fully threaded rods, each at least six inches in length, each threaded to fit on one end into a respective one of the threaded inserts of the four brackets and at an opposing end into one of the threaded inserts of the ceiling mount, indoor unit.

13. The kit of claim 11, further comprising:
four fully threaded bolts, each at least six inches in length, each threaded to fit on one end into a respective one of the threaded inserts of the four brackets and at an opposing end into one of the threaded inserts of the ceiling mount, indoor unit.

14. The kit of claim 11, further comprising:
four threaded rods or bolts, such that the threaded inserts of the respect brackets are configured to be threaded to a respect one of the four bolts or rods, each having opposing ends threaded to a respective one of four threaded inserts of the ceiling mount, indoor unit, wherein the brackets are configured such that downward vertical forces resulting from gravity is countered by substantially equivalent upward vertical forces applied to the brackets by virtue of being connected via the bolts or rods at the threaded insert of the respective brackets.

15. The kit of claim 11, wherein each of the brackets comprise an approximately ¼ inch, substantially 90 degree bend running approximately a whole length of each side of the bracket configured for enhanced structural support and strength.

16. The kit of claim 11, each of the brackets, further comprising:
a plurality of holes pre-punched into the base support member at least a portion of the holes running in parallel along a length of the bracket below the U-shaped support configured for screw attachment to a framing.

17. The kit of claim 16, wherein the plurality of holes comprises at least six holes, arranged at approximately equal distances in a set two approximately parallel lines running along the length of the bracket, one of the approximately parallel lines of the holes being on a right and the other being on a left side of the length.

18. The bracket of claim 17, wherein the at least six holes comprises ten holes, wherein each of the parallel lines comprise five holes.

19. The kit of claim 11, wherein each U-shaped support member of the brackets is configured to contain and support an endpoint of a standard sized uni-strut between the U-shaped opening, such that two of the brackets facing each other support both endpoints of the uni-strut within respective U shaped support members.

20. A mounting for installation of a ceiling mount, indoor unit of a ductless split HVAC system, comprising:
four brackets, each comprising:
a base support member made from sheet steel, having a length of between 13 inches and 8 inches and a width between 5 inches and 2 inches; and
a U-shaped support made from sheet steel, welded to the base support member, which has a topmost portion representing an open portion of the U shape located between 0 and 4 inches from a top of the base support member and approximately centered on the base support member, said U-shaped support comprising:
a threaded insert centered in a bottom section of the U-shape, wherein said threaded insert is configured to thread a bolt or rod having an opposing threaded end configured to be threaded to one of four threaded inserts of the ceiling mount, indoor unit;
a plurality of holes pre-punched into each of the base support members, at least a portion of said plurality of holes running in parallel along a length of the bracket below the U-shaped support configured for screw attachment to a framing;
four threaded rods or bolts, such that the threaded inserts of the respect brackets are configured to be threaded to a respect one of the four bolts or rods, each having opposing ends threaded to a respective one of four threaded inserts of the ceiling mount, indoor unit, wherein the brackets are configured such that downward vertical forces resulting from gravity is countered by substantially equivalent upward vertical forces applied to the brackets by virtue of being connected via the bolts or rods at the threaded insert of the respective brackets; and
a framing configured to surround an outer perimeter of the ceiling mount, indoor unit, said framing connecting to each of the four brackets on the interior of the framing via screws connecting through the holes.
